(19) United States
(12) Patent Application Publication
(10) Pub. No.: US 2020/0202697 A1
(43) Pub. Date: Jun. 25, 2020

(54) SYSTEM FOR MONITORING THE PRESENCE OF INDIVIDUALS IN A ROOM AND METHOD THEREFOR

(71) Applicant: MEZRIT PTY LTD., BONDI JUNCTION (AU)

(72) Inventors: DAVID GIRLE, CHANDLER, AZ (US); MURRAY BAKER, ROSEVILLE (AU)

(21) Appl. No.: 16/709,626

(22) Filed: Dec. 10, 2019

Related U.S. Application Data
(60) Provisional application No. 62/783,006, filed on Dec. 20, 2018.

(51) Int. Cl. G08B 21/04; G08B 13/19

(52) U.S. Cl. CPC G08B 21/0469; G08B 13/19

(57) ABSTRACT

A presence detection system has at least one presence sensing monitor. The presence sensing monitor has a motion sensor detecting moving objects in an area being monitored by the presence detection system. A thermal image sensor provides a thermal image of the area being monitored by the presence detection system. A processor receives and analyzes signals from the motion sensor and the thermal image sensor to determine a presence of an individual in the area being monitored. The presence sensing monitor has a transmitter. The presence detection system has a monitoring and reporting device wirelessly coupled to the presence sensing monitor.

### TECHNICAL FIELD

The present application generally relates to detection systems and, more particularly, to a system for the detection and monitoring of the presence or absence of one or more people in confined areas or rooms, typically for safety but also for access restriction.

### BACKGROUND

Systems and devices for sensing and/monitoring the presence of one or more individuals in a confined space are well known. These types of devices may be used for security purposes such as to signal when there is an unauthorized entry into a room. These types of devices have also been used to make sure certain individuals remain present in a room for safety reasons such as a patient in a hospital room.

In a hospital setting, it may be important for medical providers to know whether certain patients remain in their medical bed or hospital chair located within the room. Reasons for this may include, but are not limited to, to quickly locate the patient, administer medical treatment to the correct patient, and the prevention of patient injury. Such knowledge is particularly important when patients have become disoriented due to illness or medication.

In past presence monitoring systems, pressure sensors located in the medical bed and/or chair were used to indicate occupancy. These systems were typically equipped with an alarm or were electronically tied to a common monitoring location, such as a nurses' station. However, for patients that are not bed ridden, many false alarms may be sounded as the patient gets in and out of their medical bed and/or chair.

Another type of presence monitoring system are ones that monitor when a person enters or exits a room. These types of systems may have a sensor located on the door of the room and may monitor when the door is open and closed to determine whether the room is occupied. A problem with this type of presence system is that the sensor is primarily positioned on the main door entering the hospital room. Thus, it is unable to determine if a person has entered a bathroom section of the hospital room. Further, these types of systems may fail to detect someone spending an excessive amount of time in a location, such as a hospital patient spending too much time motionless in an adjoining bathroom, indicating a potential medical situation.

Therefore, it would be desirable to provide a system and method that overcome the above problems.

### SUMMARY

In accordance with one embodiment, a presence detection system is disclosed. The presence detection system has at least one presence sensing monitor. The presence sensing monitor has a motion sensor detecting moving objects in an area being monitored by the presence detection system, a thermal image sensor providing a thermal image of the area being monitored by the presence detection system; a processor receiving and analyzing signals from the motion sensor and the thermal image sensor to determine a presence of an individual in the area being monitored; and a transmitter. The presence detection system has a monitoring and reporting device wirelessly coupled to the presence sensing monitor.

In accordance with one embodiment, a presence detection system is disclosed. The presence detection system has at least one presence sensing monitor. The presence sensing monitor has a motion sensor detecting moving objects in an area being monitored by the presence detection system; a thermal image sensor providing a thermal image of the area being monitored by the presence detection system; a light sensor monitoring changes in light intensity of the area being monitored by the presence detection system; a processor receiving and analyzing signals from the motion sensor, the thermal image sensor and the light sensor to determine a presence of an individual in the area being monitored; an interface board coupled to the motion sensor, the thermal image sensor and the processor; a power supply coupled to the interface board and a transmitter. The presence detection system has a monitoring and reporting device wirelessly coupled to the presence sensing monitor.

### BRIEF DESCRIPTION OF THE DRAWINGS

The present application is further detailed with respect to the following drawings. These figures are not intended to limit the scope of the present application but rather illustrate certain attributes thereof the same reference numbers will be used throughout the drawings to refer to the same or like parts.

FIG. 1 is a block diagram of a presence monitoring device according to one aspect of the present application;

FIG. 2 is a perspective view of the presence monitoring device of FIG. 1 position above a door according to one aspect of the present application; and

FIG. 3 is a block diagram of the presence monitoring device and associated network according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary presence detection system is to combine a thermal imaging sensor with a door switch, light sensor and motion detector. The door switch, light sensor and motion sensors may be used to determine room presence. For high reliability situations, such as medical care, thermal imaging sensors may be used to verify presence by body heat. The combination and correlation of entry and movement with the thermal imaging sensors may be used to continuously improve the detection algorithm. The data collected may be used to establish thermal baselines and by correlation, determine if an imaging algorithm is not performing as desired.

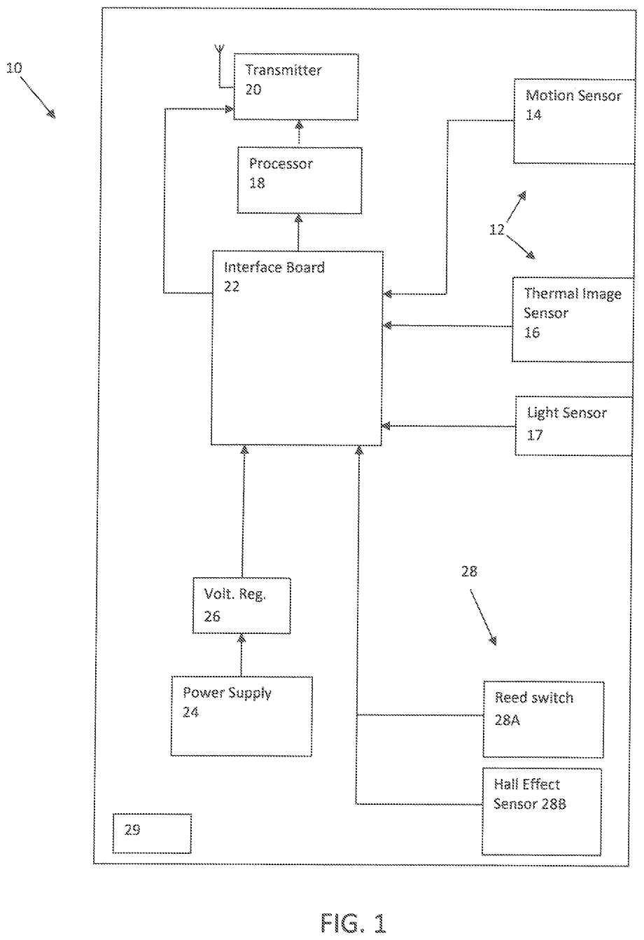

Referring to FIG. 1, an exemplary block diagram of a presence sensing device 10 (device 10) may be seen. The device 10 may use motion sensing and thermal imaging to determine the presence of an individual in a particular pre-defined area.

The device 10 has a plurality of presence sensing devices 12 and 28. In accordance with one embodiment, the device 10 has a motion sensor 14, a thermal imaging sensor 16 and a light sensor 17. The motion sensor 14 may be used to detect moving objects, particularly people within a predefined area. The motion sensor 14 may be an infrared (IR) sensor, microwave sensor, ultrasonic sensor or similar technology.

In accordance with one embodiment, the motion sensor 14 may be an infrared (IR) motion sensor. IR motion sensors measure IR light radiating from objects in its field of view. In general, all objects with a temperature above absolute zero emit heat energy in the form of radiation. Usually this radiation isn't visible to the human eye because it radiates at infrared wavelengths, but it can be detected by IR motion sensors. When there is a sudden increase in IR energy, the IR motion sensor will send a signal indicating detection of an object. Small fluctuations in IR energy will not be detected by the IR motion sensor, such as, but not limited to: sun rising and setting, changing the thermostat temperature slightly, and the like. In accordance with one embodiment, the IR motion sensor may be a passive IR (PIR) motion sensor. The term passive may refer to the fact that PIR motion sensor does not generate or radiate energy for detection purposes. The PIR motion sensor works entirely by detecting infrared radiation emitted by or reflected from objects.

The thermal imaging sensor 16 may be used to complement the motion sensor 14. The thermal imaging sensor 16 may be used to provide a thermal image of its field of view. To limit the size and power usage, and to preserve privacy, the thermal imaging sensor 16 may generate a low-resolution thermal image. In accordance with one embodiment, the thermal imaging sensor 16 may generate a low-resolution thermal image in a range of 1×1 to 32×32 pixels.

In accordance with one embodiment, a thermal imaging sensor 16, typically sensitive in the range of 0-80° C., for monitoring humans, may be used. The typical human core temperature may be approximately 37° C. while the typical ambient air in a typical air-conditioned environment may be approximately 24° C., providing sufficient differential upon signal filtering to detect human presence, whether moving or not. By increasing the resolution of the detector within the aforementioned limits, additional scene information may be extracted, such as direction of vertical or horizontal motion and person counting, while still maintaining privacy.

The device 10 may have a light sensor 17. The light sensor 17 may generate an output signal indicating an intensity of light by measuring the radiant energy that exists in a very narrow range of frequencies. These frequencies may range in frequency from “Infra-red” to “Visible” up to “Ultraviolet” light spectrum. In accordance with one embodiment, the light sensor 17 may measure light in the “Visible” frequency range. The “Visible” frequency range may be in a band in the vicinity of 430-770 THz. The light sensor 17 may be used to detect both switching of the lights in the room, as someone enters and exits, and movement in the room, by variation in reflected light.

The motion sensor 14, the thermal imaging sensor 16 and light sensor may be coupled to a microprocessor 18. Depending on battery life considerations, the microprocessor 18 may be used to preform processing of the signals received from the motion sensor 14, the thermal imaging sensor 16 and the light sensor 17, or the signals may be transmitted to a detection router 42 via a transmitter 20, for processing. In accordance with one embodiment, the transmitter 20 may be a wireless transmitter. The processed signals may be sent to a monitoring station/device, a data collection server or similar devices.

An interface board 22 may be positioned between the motion sensor 14, the thermal imaging sensor 16, the light sensor 17 and the microprocessor 18. The interface board 22 may be used to provide the necessary power and signal conditioning of the signals received from the motion sensor 14, the thermal imaging sensor 16 and light sensor 17 prior to sending the signals to the microprocessor 18

A power supply 24 may be used to power the components of the device 10. The power supply 24 may be any type of power source. In accordance with one embodiment, for easy and flexibility of installation and mounting, the power source may be a battery. The power source 24 may have a voltage regulator 26. The voltage regular 26 may be used to regulate and provide a constant voltage level for components of the device 10.

The device 10 may have an activation sensor 28. The activation sensor 28 may be used to indicate when a door upon which the device 10 is attached to the frame of is opened or closed. In accordance with one embodiment, the activation sensor 28 may be a non-contact switch such as a reed switch 28A or digital Hall Effect sensor 28B. A reed switch 28A may contain a pair of magnetizable, flexible, metal reeds whose end portions are separated by a small gap when the reed switch 28A is open. The metal reeds may be sealed in opposite ends of a tubular container. A magnet field from an electromagnet, permanent magnet or the like may cause the reeds to attract each other, thereby completing an electrical circuit. The spring force of the reeds causes them to separate, and open the circuit, when the magnetic field ceases.

A digital Hall Effect sensor 28B is a device that is used to measure the magnitude of a magnetic field. The Hall Effect sensor 28B may generate an output signal directly proportional to the magnetic field strength through it. The Hall Effect sensor 28B may work in a similar manner as the reed switch 28A, in that when the magnetic flux density measured exceeds a threshold, the output switches.

Thus, the activation sensors 28 may be used to signal the components of the device 10 that the door is either dosed or open. Thus, the activation sensor 28 may be used to conserve energy usage for the device 10. Multiple activation sensors 28 may be included in the device 10 at the side and bottom edges of the door/frame, to simplify mounting and offer more choices in the location of the magnet on the door.

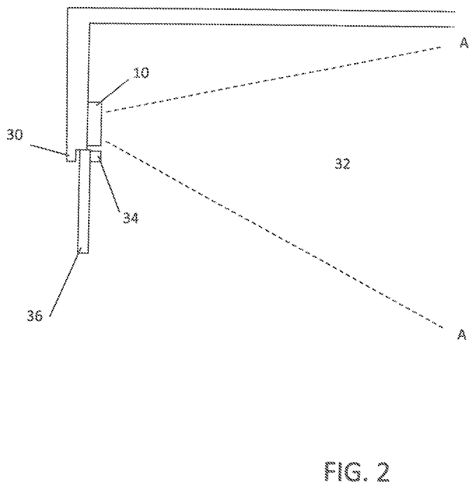

Referring to FIG. 2, the device 10 may be seen attached to a door frame 30. The device 10 may be able to monitor an area 32 indicated by the lines A-A. In the present embodiment, a magnet 34 may be attached to a door 36 which is movably attached to the door frame 30 via hinges (not shown). The magnet 34 may be used to form a magnet field to signal the components of the device 10 when the door 36 is closed against the door frame 30. When the door 36 is open, the magnetic field is moved away again signaling the device 10 of the position of the door 36.

To improve the reliability of the device 10, the outputs of the sensors 12 and 28 in the device 10 may be combined with either or both deterministic or machine learning algorithm(s), to minimize the likelihood of false alarms. In a traditional system, relying upon only one of the included sensors, the system may be defeated in the course of typical human usage of the facility. For example, a system comprising of only a door sensor may be rendered useless by the door being wedged open. A system comprising only of a motion detector may fail to detect a person who became motionless because of a medical situation. A system comprising only a thermal imager may not detect failure of the sensor. By way of illustration, the following table shows the conditions that may be determined by combining the sensor input.

| State | Door | Motion | Thermal |
|---|---|---|---|
| Room empty | 0 | 0 | 0 |
| Room occupied, people motionless | 0 | 0 | 1 |
| Potential thermal sensor failure | 0 | 1 | 0 |
| Room occupied, people moving | 0 | 1 | 1 |
| Door opens | 1 | 0 | 0 |
| Door open, room occupied, people motionless | 1 | 0 | 1 |
| People entering | 1 | 1 | 0 |
| People move in/out of the room | 1 | 1 | 1 |

Machine learning may also be applied to detect usage patterns and limit false alarms. In some situations, doors may always be open or lights always on, whereas in others, the door or room light action may be indicative of people entering or leaving the room.

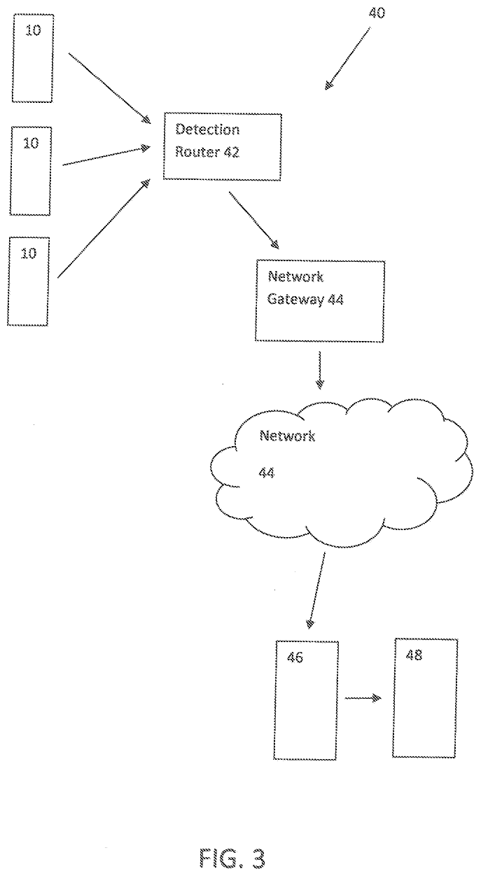

Depending on the sophistication of processing, resolution of the thermal imager and required battery life, sensor algorithms may either be run locally on device 10 or on a detection router 42 (FIG. 3) as will be disclosed below. To effectively run as a communications router, the detection router 42 may be powered on normally and thus usually by AC power. Where device 10 must run for extended periods on battery, one embodiment is to transmit sensor data from device 10 to the detection router 42 for analysis and allowing device 10 to conserve power.

Referring to FIGS. 1-3, the device 10 may transmit the data collected to a monitoring/collecting system 40. In accordance with one embodiment, the data may be transmitted by the device 10 to the monitoring/collecting system 40 wirelessly. The monitoring and collecting system 40 may collect and process the data collected from all devices 10 coupled thereto.

In accordance with the embodiment shown, the devices 10 in one location, for example one floor of a hospital, may transmit the data monitored to a detection router 42. The detection router 42 may collect and process the data from each device 10 and determine whether a human is in the area 32 being monitored by each device 10. If a human is detected, this information may be sent wirelessly to a network gateway 44. The network gateway 44 may be used to marshal the signals from all the detection routers 42 and transmit them to cloud storage 46 via a network 44. The network 44 may be a local area network (LAN), a general wide area network (WAN), wireless local area network (WLAN) and/or a public network. The cloud storage 46 may log, store and report the data. A monitoring and reporting device 48 may be coupled to the cloud storage 46. The monitoring and reporting device 48 may be used to signal and alert personnel to any potential problems within the areas 32 being monitored. The monitoring and reporting device 48 may be a monitoring station, an app on a mobile device or any similar device.

To ensure a verifiable response to all problem reports, it may be necessary to confirm that the responsible attendant inspected the area 32 under supervision. To confirm the attendant physically was present at the occupancy monitor, the device 10 may have a confirmation device 29. The confirmation device 29 may be a mechanism that the attendant must activate to confirm that the area 32 under supervision has been inspected.

In accordance with one embodiment, the confirmation device 29 may be a machine readable code 29A. The machine readable code 29A may be a bar code, QR code or the like. The machine readable code 29A would be located in the interior of the room proximate the area 32 under supervision. In operation, if the device 10 detects a problem, to confirm that the attendant inspected the area 32 inspected the area 32, the attendant would have to scan the machine readable code 29A with a mobile code reading device 40. Once the mobile code reading device 40 reads the machine readable code 29A, the mobile code reading device 50 may send a wireless signal to the detection router 42 to confirm the attendant was viewing the same supervised area 32 as device 10.

The machine readable code 29A may limit false positives associated with other wireless technologies. For example, a problem with solely using Bluetooth beacons to indicate position, is that they are readable through a locked door, whereas a tag scanner requires line of sight and thus must be read at the supervised area 32, inside the room under supervision. By combining a Bluetooth beacon and machine readable code 29A, it, is possible to prevent another system subversion, where images of the machine readable code 29A are captured and stored at a convenient location. Rather than inspecting the area under supervision, personnel could merely scan the stored copy of the code. Using a Bluetooth beacon as part of device 10, to transmit a secure unique code, requires personnel to not only scan the machine readable code 29A but also be physically close to device 10.

To ensure alarms are not ignored or forgotten, it is possible to define an escalation policy, hereby if a response to the occupancy alarm is not confirmed within a defined time, a supervisor gets an alert. This escalation process may be repeated through the chain of responsibility for the facility.

The above confirmation device 29 is given as an example and should not be seen in a limiting manner. Other types of confirmation devices 29 may be used without departing from the spirit and scope of the present invention. For example, a press button mechanism could also be used. In this embodiment, the attendant would have to enter the area 32 in order to press the press button mechanism. Pressing the press button mechanism would then send a wireless signal to the detection router 42.

To facilitate simple and accurate installation of the device 10, one embodiment may use a camera in place of the thermal image sensor 16, with a lens to match the viewing area 32 of the thermal imager. A mobile device, such as phone, may then be able to view video streamed from the device 10, as it is positioned on the door 36. One embodiment may use stacks of fixed angle shims, to set the horizontal and vertical orientation of the device 10 relative to the door 36 and room. Once the desired view has been found, an image can be captured off the video stream for commissioning records together with the corresponding combination of shims. Using fixed angle shin s minimizes the chance of the viewing field changing due to vibration or physical interference.

To improve the quality assurance of the system 40, one embodiment of the manufacturing toolling for the device 10, detection router 42 and network gateway 44 may include usage of a firmware installation and test appliance. The appliance may be delivered to the manufacturing and test facility from the development facility, and via a communications link, in one embodiment cellular wireless, downloads test and production software from the cloud services 46. A user interface on the test appliance, may enable test firmware for the manufactured devices 10, 42 and 44 to be downloaded from the cloud services 46 and loaded to the devices directly via a programming link, such as a JTAG link. Test results for each device 10 may be captured on the test appliance via the programming link and transmitted to the cloud services 46. Production firmware may then be downloaded to the manufactured devices, from the test appliance, again recording the results to the cloud services 46. In this way, not only is testing automated, but all results are captured directly to the cloud services 46, without any need to transmit test or production firmware or procedures to the manufacturing or test facility, for significant protection of intellectual property.

The foregoing description is illustrative of particular embodiments of the application, but is not meant to be a limitation upon the practice thereof. The following claims, including all equivalents thereof, are intended to define the scope of the application.

What is claimed is:

1. A presence detection system comprising:
at least one presence sensing monitor comprising:
a motion sensor detecting moving objects in an area being monitored by the presence detection system;
a thermal image sensor providing a thermal image of the area being monitored by the presence detection system;
a processor receiving and analyzing signals from the motion sensor and the thermal image sensor to determine a presence of an individual in the area being monitored; and,
a transmitter; and
a monitoring and reporting device wirelessly coupled to the presence sensing monitor.

2. The presence detection system in accordance with claim 1, wherein the presence sensing monitor comprises a light sensor monitoring changes in light intensity of the area being monitored by the presence detection system.

3. The presence detection system in accordance with claim 1, wherein the presence sensing monitor comprises an interface board coupled to the motion sensor, the thermal image sensor and the processor.

4. The presence detection system in accordance with claim 3, wherein the presence sensing monitor comprises a power supply coupled to the interface board.

5. The presence detection system in accordance with claim, 4, wherein the power supply is a battery.

6. The presence detection system in accordance with claim 3, wherein the presence easing monitor comprises an activation sensor coupled to the interface board.

7. The presence detection system accordance with claim 1, comprising a detection router wirelessly coupled to the at least one presence sensing monitor.

8. The presence detection system in accordance with claim 1, comprising a monitoring and reporting device coupled to the at least one presence sensing monitor.

9. The presence detection system in accordance with claim 1, wherein the motion sensor is one of: an infrared (IR) sensor, microwave sensor, or ultrasonic sensor.

10. The presence detection system in accordance with claim 1, wherein the motion sensor is a passive infrared (PIR) sensor.

11. The presence detection system in accordance with claim 1, wherein the thermal image sensor generates a low resolution thermal image.

12. The presence detection system in accordance with claim 2, wherein the light sensor monitors the light intensity in a visible frequency range.

13. The presence detection system in accordance with claim 2, wherein the light sensor monitor the light intensity in a band of 430-770 THz.

14. A presence detection system comprising:
at least one presence sensing monitor comprising:
a motion sensor detecting moving objects man area being monitored by the presence detection system;
a thermal image sensor providing a thermal image of the area being monitored by the presence detection system;
a light sensor monitoring changes in light intensity of the area being monitored by the presence detection system;
a processor receiving and analyzing signals from the motion sensor, the thermal image sensor and the light sensor to determine a presence of an individual in the area being monitored;
an interface board coupled to the motion sensor, the thermal image sensor and the processor;
a power supply coupled to the interface board and
a transmitter; and
a monitoring and reporting device wirelessly coupled to the presence sensing monitor.

15. The presence detection system in accordance with claim 14, wherein the power supply is a battery.

16. The presence detection system in accordance with claim 14, wherein the presence sensing monitor comprises an activation sensor coupled to the interface board.

17. The presence detection system in accordance with claim 14, comprising a detection router wirelessly coupled to the at least one presence sensing monitor.

18. The presence detection system in accordance with claim 14, comprising a monitoring and reporting device coupled to the at least one presence sensing monitor.

19. The presence detection, system in accordance with claim 14 wherein the motion sensor is a passive infrared (PIR) sensor.

20. The presence detection system in accordance with claim 14, wherein the light sensor monitors the light intensity in a visible frequency range.
